(19) United States
(12) Patent Application Publication
(10) Pub. No.: US 2005/0087608 A1
(43) Pub. Date: Apr. 28, 2005

(54) Semiconductor device and manufacturing method thereof, a pet substrate and manufacturing method thereof

(76) Inventor: Tomoyuki Shindo, Nagano-ken (JP)

Correspondence Address: HARNESS, DICKEY & PIERCE, P.L.C., P.O. BOX 828, BLOOMFIELD HILLS, MI, 48303, US

(21) Appl. No.: 10/943,145

(22) Filed: Sep. 16, 2004

(30) Foreign Application Priority Data
Sep. 19, 2003 (JP) 2003-327685

(51) Int. Cl. G06K 19/06

(52) U.S. Cl. 235/492

(57) ABSTRACT

A semiconductor device is provided comprising: a PET substrate including a lightfast dye that restrains the transmittance of light; an antenna coil formed on the PET substrate; and an IC chip placed on the antenna coil with an active surface thereof facing the antenna coil; wherein one end of the antenna coil is electrically coupled to a first bump on the active surface of the IC chip and the other end of the antenna coil is electrically coupled to a second bump on the active surface of the IC chip.

### RELATED APPLICATIONS

This application claims priority to Japanese Patent Application No. 2003-327685 filed Sep. 19, 2003, which is hereby expressly incorporated by reference herein in its entirety.

### BACKGROUND

1. Technical Field

The present invention is related to a semiconductor device for an integrated circuit (IC) tag, a manufacturing method for the semiconductor device, a polyester (PET) substrate and a manufacturing method for the PET substrate. More particularly, the invention relates to a semiconductor device which can restrain the amount of light (radiation) reaching an active surface of an IC chip.

2. Related Art

FIG. 2 shows a sectional view of a conventional semiconductor device. This semiconductor device is an IC tag used in logistics applications. The semiconductor device includes a transparent PET substrate 101. An antenna coil 102 is installed on the PET substrate 101. The coil 102 performs non-contact data communication with other pieces of equipment via electromagnetic induction.

An IC chip 103, which generates a signal in response to an input received from a memory unit or a Central Processing Unit (CPU), is installed on the antenna coil 102. The IC chip 103 outputs modulated specific information stored in the memory from the antenna coil 102 when responding the remote equipment by communication without contact. The active surface of the IC chip 103 faces the antenna coil 102. Bumps 104 and 105 are installed on the active surface of the IC chip 103. The bumps 104 and 105 are electrically coupled to the semiconductor circuit within the IC chip 103.

The bump 104 is connected to one end of the antenna coil 102 via a conductive adhesive 106. The bump 105 is connected to the other end of the antenna coil 102 via the conductive adhesive 106.

In the conventional semiconductor device illustrated in FIG. 2, light (radiation) 107 such as UV radiation from the outside may reach the active surface of the IC chip 103 because the PET substrate 101 is transparent. Thus, some data in the IC chip 103 may be lost or damaged.

To address this problem in conventional manufacturing processes for an optical and non-contact IC hybrid card, a laminate roll composed of a metal bonds a non-contact IC sheet to a transparent substrate to form an optical recording layer. In other cases, metal layers are laminated on the surface of the non-contact IC sheet. Unfortunately, manufacturing costs increase when the surface of a laminate is metalized or metal layers are laminated on the surface of an IC sheet.

In view of the above issues, the present invention is intended to provide a semiconductor device which can restrain the amount of light (radiation) reaching an active surface of an IC chip, a method of manufacturing the semiconductor device, a PET substrate, and a manufacturing method of the PET substrate.

### SUMMARY

In order to solve the above problems, the semiconductor device of the present invention comprises: a flexible substrate including a lightfast dye that restrains the transmittance of light; an antenna coil formed on the flexible substrate; and an IC chip placed on and coupled to the antenna coil with an active surface of the IC chip facing the antenna coil.

The above semiconductor device can restrain the amount of light reaching the active surface of the IC chip from the outside. Hence, lost or damaged data in the IC chip due to light penetration can be prevented.

The above semiconductor device of the present invention may further comprise: a first bump formed on the active surface of the IC chip; and a second bump formed on the active surface of the IC chip; wherein one end of the antenna coil is electrically coupled to the first bump and the other end of the antenna coil is electrically coupled to the second bump.

Further, the flexible substrate in the semiconductor device of the present invention may be a PET substrate.

Further, the lightfast dye in the semiconductor device of the present invention may be a phthalocyanine or azoic dye.

Further, the lightfast dye in the semiconductor device of the present invention may be sprayed on the surface of the flexible substrate.

Further, the lightfast dye in the semiconductor device of the present invention may be mixed within the material of the flexible substrate.

The PET substrate of the present invention comprises a PET substrate for supporting an IC chip and antenna coil thereon and includes a lightfast dye restraining the transmission of light through the substrate. The PET substrate includes a lightfast dye that restrains the transmittance of light like UV radiation. When the IC chip and antenna coil are mounted on such a PET substrate, the amount of light reaching the active surface of the IC chip can be restrained. Hence, the loss of or damage to data in the IC chip due to light penetration can be prevented.

A method of manufacturing the semiconductor device of the present invention, comprises:
a step of forming a PET substrate having light stability which restrains the transmittance of light including:
   forming a liquid body by mixing a lightfast dye which restrains the transmittance of light into a solvent; and
   spraying the liquid body on the surface of a PET substrate;
a step of forming an antenna coil on the PET substrate; and
a step of placing an IC chip on the antenna coil such that the active surface of the IC chip faces the antenna coil, and electrically coupling the antenna coil with the IC chip.

The method of manufacturing the semiconductor device may further comprise:
electrically coupling one end of the antenna coil to a first bump on the active surface of the IC chip and electrically coupling the other end of the antenna coil to a second bump on the active surface of the IC chip.

An alternate method of manufacturing the semiconductor device comprises:
a step of forming a PET substrate including a lightfast dye which restrains the transmittance of light including:
   mixing a lightfast dye which restrains the transmittance of light into a liquid phase material used for forming a PET substrate; and
   molding the material including the lightfast dye into the PET substrate;
a step of forming an antenna coil on the PET substrate; and
a step of placing an IC chip on the antenna coil such that the active surface of the IC chip faces the antenna coil, and electrically coupling the antenna coil with the IC chip.

According to the above method of manufacturing the semiconductor device, a PET substrate having a lightfast dye mixed therein is used to refrain light such as UV radiation from reaching the active surface of the IC chip. Thus, the loss of or damage to data within the IC chip can be prevented.

The alternate method of manufacturing the semiconductor device of the present invention may further comprise:
electrically coupling one end of the antenna coil to a first bump on the active surface on the IC chip and electrically coupling the other end of the antenna coil to a second bump on the active surface of the IC chip.

A method of manufacturing a PET substrate of the present invention for supporting an IC and an antenna coil comprises: forming a liquid body by mixing a lightfast dye which restrains the transmittance of light into a solvent; and spraying the liquid body on the surface of the PET substrate so as to form a PET substrate including a lightfast dye which restrains the transmittance of light.

An alternate method of manufacturing the PET substrate of the present invention for supporting IC and an antenna coil comprises: mixing a lightfast dye which restrains the transmittance of light into a liquid phase of a material used to form the PET substrate; and molding the material including the lightfast dye into the PET substrate so as to form a PET substrate having a lightfast dye which restrains the transmittance of light.

### BRIEF DESCRIPTION OF THE DRAWINGS

FIGS. 1A-1C show cross section and plan views of a semiconductor device with respect to embodiment 1 of the present invention.

FIG. 2 shows a sectional view of a conventional semiconductor device.

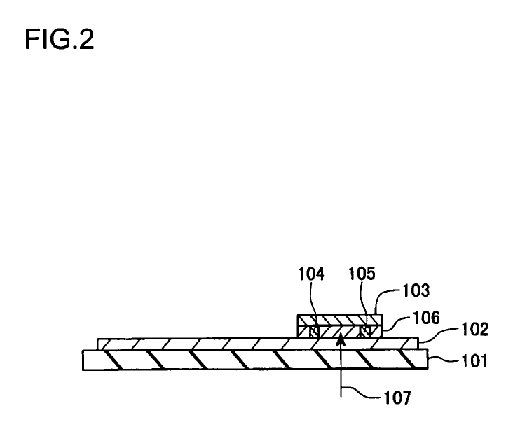

### DETAILED DESCRIPTION

The preferred embodiment of the present invention is disclosed hereafter referring to the drawings.

### Embodiment 1

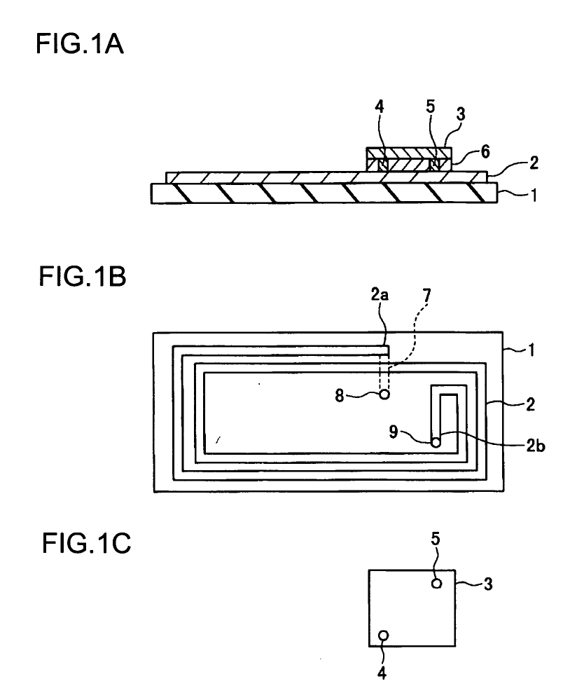

FIG. 1A shows a sectional view of a semiconductor device of embodiment 1 of the invention. FIG. 1B shows a plan view of the PET substrate disclosed in FIG. 1A. FIG. 1C shows a plan view of the active surface of the IC chip disclosed in FIG. 1A. This semiconductor device is an example of an IC-tag utilized in logistic applications with relatively weak wireless communication.

As shown in FIGS. 1A and 1B, the semiconductor device includes a PET substrate 1. The PET substrate 1 includes a lightfast dye which is resistant to the transmission of light such as UV radiation. The lightfast dye may be sprayed onto a surface of the PET substrate or may be mixed into the PET substrate itself. The dye is preferably a phthalocyanine or azoic dye. However, other dyes may be used so long as they have lightfast characteristics which prevent the transmission of light such as UV radiation.

As shown in FIG. 1B, an antenna coil 2 is disposed on the PET substrate 1 to perform data communication with external devices via electromagnetic induction. The antenna coil 2 spirals inwardly from an outboard portion of the upper surface of the PET substrate 1. One end 2a of the antenna coil 2 is connected to the end of a conductive connector 7 and a connecting pad 8 is connected to the other end of the connector 7. It is possible to employ various kinds of connecting means as the connector 7 so long as the end 2a of the antenna coil 2 is electrically connected to the connecting pad 8. A connecting pad 9 is connected to the other end 2b of the antenna coil 2.

As shown in FIG. 1A, an IC chip 3, which generates a signal in response to an input from a memory or a CPU, is disposed on the antenna coil 2. The IC chip 3 outputs modulated specific information stored in the memory from the antenna coil 2 when responding external equipment by communication without contact. The active surface of the IC chip 3 faces the antenna coil 2. As shown in FIG. 1C, bumps 4 and 5 are installed on the active surface of the IC chip 3. Bumps 4 and 5 are electrically connected to the semiconductor circuit in the IC chip 3.

The bump 4 is connected to the pad 8 via a conductive adhesive 6 and the bump 5 is connected to the pad 9 via the conductive adhesive 6.

According to embodiment 1, the above semiconductor device can restrain the amount of light reaching the active surface of the IC chip 3 from the outside because the PET substrate 1 includes a lightfast dye that restrains the transmittance of light like UV radiation. As such, the loss of or damage to data within the IC chip 3 can be prevented. Advantageously, this can be accomplished at low cost.

Next, one method of manufacturing the semiconductor device shown in FIG. 1 is explained.

First, a lightfast dye such as phthalocyanine or azoic dye which prevents the transmission of light such as UV radiation is prepared. In this condition, the dye is granular or “mealy”. Also at this time a PET sheet is prepared to be suitable for yielding a PET substrate.

Next, the lightfast dye is mixed with a solution and rendered a liquid state. Then the liquid dye is sprayed on the surface of the PET sheet. Thus, a lightfast PET sheet is formed. Next, the lightfast PET sheet is divided (cut) into a specific size to yield the PET substrate 1.

A metal film made of, for example, Cu, Al, Cu alloy, or Al alloy is attached to the surface of the PET substrate 1 with an adhesive. Next, an etchable photoresist film (not shown in the figure) is applied to the metal film by, for example, a screen printing technique. The photoresist film is patterned to leave wirings for forming the antenna coil after etching. Thereafter, the metal film is etched by dipping or otherwise with a chemical such as iron chloride. Thereafter, the spiral antenna coil and connecting pads 8 and 9 are formed on the PET substrate 1. Subsequently, the one end 2a of the antenna coil 2 is electrically connected to the connecting pad 8 via the connector 7.

Next, the IC chip 3 is prepared. The bumps 4 and 5 are formed on the active surface of the IC chip 3. Further, the IC chip 3 is mounted on the antenna coil 2 and the bump 4 of the IC chip 3 is electrically connected to the connecting pad 8 via the conductive adhesive 6. The bump 5 of the IC chip 3 is electrically connected to the connecting pad 9 via the conductive adhesive 6. Thus, the semiconductor device shown in FIG. 1A is formed.

### Embodiment 2

Embodiment 2 of the present invention is directed towards a method of manufacturing a semiconductor device. In embodiment 2, only the method of manufacturing the PET substrate is different from the method of embodiment 1. Other portions of the method are the same as those in embodiment 1 and their explanation is omitted. According to the method of manufacturing the PET substrate in embodiment 2, the PET substrate is formed by molding a base material of the PET substrate after uniformly mixing a lightfast dye into the PET base material.

More particularly, a detailed explanation of an exemplary method of manufacturing the PET substrate will now be explained. Terephthalic acid is directly esterification reacted with ethylene glycol to generate bis(2-hydorxide-ethyl) terephthalate. This esterification-reaction is reversible so that water generated during the reaction can be removed to perfectly convert the starting material into bis(2-hydorxide-ethyl) terephthalate. In this direct esterification-reaction, no catalyst is needed.

Next, the bis terephthalate is polycondensation-reacted with an antimony catalyst to form a PET material. Further, phthalocyanine or azoic dye is uniformly mixed into the PET material. Then, the mixed PET material is molded into the PET substrate. The molded substrate of embodiment 2 shows the same effect as the sprayed substrate of embodiment 1.

Namely, the amount of light reaching the active surface of the IC chip 3 from the outside is restrained since the PET substrate 1 includes a lightfast dye that restrains the transmittance of light such as UV radiation. Hence, the loss of or damage to data in the IC chip 3 can be prevented. Further, this can be accomplished at a relatively low cost.

The present invention is not limited to the above-mentioned embodiments and can be variously modified within a spirit and scope of the present invention. For example, although a PET substrate is used in the above embodiments, other flexible substrates may be used. Further, the method for uniformly mixing the lightfast dye into a base material of the PET substrate is not limited to the example provided in embodiment 2 and it is possible to use other methods.

1. A semiconductor device comprising:
a flexible substrate including a lightfast dye that restrains light transmittance;
an antenna coil on the flexible substrate; and
an IC chip on the antenna coil;
wherein an active surface of the IC chip faces the antenna coil and the IC chip is coupled to the antenna coil.

2. The semiconductor device of claim 1 wherein:
one end of the antenna coil is electrically coupled to a first bump on the active surface of the IC chip; and
another end of the antenna coil is electrically coupled to a second bump on the active surface of the IC chip.

3. A semiconductor device according to claim 1, wherein the flexible substrate comprises a PET substrate.

4. A semiconductor device according to claim 1, wherein the lightfast dye is disposed on the flexible substrate.

5. A semiconductor device according to claim 1, wherein the flexible substrate contains the lightfast dye.

6. A semiconductor device according to claim 1, wherein the lightfast dye comprises at least one of phthalocyanine and azoic dye.

7. A PET substrate for supporting an IC and an antenna coil for an IC tag, the PET substrate comprising:
polyester; and
a lightfast dye associated with the polyester.

8. A method of manufacturing a semiconductor device, comprising:
a step of forming a flexible substrate having light stability which restrains light transmittance including:
forming a liquid body by mixing a lightfast dye which restrains light transmittance into a solvent; and
disposing the liquid body on a surface of a PET substrate;
a step of forming an antenna coil on the flexible substrate; and
a step of placing an IC chip on the antenna coil such that an active surface of the IC chip faces the antenna coil, and electrically coupling the antenna coil with the IC chip.

9. The method of manufacturing the semiconductor device of claim 8 further comprising:
electrically coupling one end of the antenna coil to a first bump on the active surface of the IC chip; and
electrically coupling another end of the antenna coil to a second bump on the active surface of the IC chip.

10. A method of manufacturing a semiconductor device, comprising:
a step of forming a PET substrate having a lightfast dye which restrains light transmittance including:
mixing a lightfast dye into a PET material; and
molding the material with the lightfast dye mixed therein into the PET substrate;
a step of forming an antenna coil on the PET substrate; and
a step of placing an IC chip on the antenna coil such that an active surface of the IC chip faces the antenna coil, and electrically coupling the antenna coil with the IC chip.

11. The method of manufacturing the semiconductor device of claim 10 further comprising:
electrically coupling one end of the antenna coil to a first bump on the active surface of the IC chip; and
electrically coupling another end of the antenna coil to a second bump on the active surface of the IC chip.

12. A method of manufacturing a flexible substrate for supporting an IC and an antenna coil for an IC tag, the method comprising:
forming a liquid body by mixing a lightfast dye which restrains light transmittance into a solvent;
disposing the liquid body on a surface of a PET substrate.

13. A method of manufacturing a flexible substrate for supporting an IC and an antenna coil for an IC tag, the method comprising:
mixing a lightfast dye which restrains light transmittance into PET to form a liquid material; and
molding the liquid material to form the flexible substrate.
